(19) United States
(12) Patent Application Publication
(10) Pub. No.: US 2015/0254082 A1
(43) Pub. Date: Sep. 10, 2015

(54) REMOTE BOOTING OVER PCI EXPRESS USING SYNTHETIC REMOTE BOOT CAPABILITY

(71) Applicant: PLX Technology, Inc., Sunnyvale, CA (US)

(72) Inventors: Rajendran VISHWANATHAN, San Jose, CA (US); Nagarajan SUBRAMANIYAN, San Jose, CA (US); Jeffrey M. DODSON, Portland, OR (US); Jack REGULA, Durham, NC (US)

(73) Assignee: PLX Technology, Inc., Sunnyvale, CA (US)

(21) Appl. No.: 14/203,149

(22) Filed: Mar. 10, 2014

(51) Int. Cl. G06F 9/44; G06F 13/40

(52) U.S. Cl. CPC G06F 9/4416; G06F 13/4022

(57) ABSTRACT

A method of remote booting over PCI Express using a synthetic remote boot capability is provided. A management host software system intercepts probe requests from a host and provided information required for a remote boot. The management host software system may include expansion ROM information to support different host architectures. A synthetic device booting capability may be shown to a host, including the expansion ROM information. Additional support for DHCP and TFTP may be provided.

### BACKGROUND OF THE INVENTION

1. Field of the Invention

The present invention relates generally to switches and electronic communication. More specifically, the present invention relates to switching between multiple hosts and multiple synthetic or logical devices in an intelligent PCIe switch.

2. Description of the Related Art

Computer architectures have advanced greatly over the years. Lately, it is becoming more and more commonplace for chip designers to include external data interfaces, such as Universal Serial Bus (USB) interface controllers into their motherboards. These interfaces are known as host controllers. The processor is typically then connected to the other components of the computer system via an input/output (I/O) interconnect system.

There are many different computer I/O interconnect standards available. One of the most popular over the years has been the peripheral component interconnect (PCI) standard. PCI allows the bus to act like a bridge, which isolates a local processor bus from the peripherals, allowing a Central Processing Unit (CPU) of the computer to connect to a host of IO devices through this interconnect.

Recently, a successor to PCI has been popularized, termed PCI Express (or, simply, PCIe). PCIe provides higher performance, increased flexibility and scalability for next-generation systems, while maintaining software compatibility with existing PCI applications. Compared to legacy PCI, the PCI Express protocol is considerably more complex, with three layers—the transaction, data link and physical layers.

In a PCI Express system, a root complex device connects the processor and memory subsystem to the PCI Express switch fabric comprised of one or more switch devices (embodiments are also possible without switches, however). In PCI Express, a point-to-point architecture is used. Similar to a host bridge in a PCI system, the root complex generates transaction requests on behalf of the processor, which is interconnected through a local I/O interconnect. Root complex functionality may be implemented as a discrete device, or may be integrated with the processor. A root complex may contain more than one PCI Express port and multiple switch devices can be connected to ports on the root complex or cascaded.

One problem in the prior art is that there are signification limitations on the ability to perform a remote booting operation. Conventionally, an Expansion ROM (also known as an Option ROM) is required to perform a boot operation. The Expansion Rom typically consists of firmware and may, for example, reside on a physical card. The Expansion Rom is loaded very early in a boot process. Typically a particular host architecture requires its own Expansion Rom. For example, a host system using an Intel-based chip architecture requires a different Expansion ROM than a host having non-Intel based chip architecture

The conventional approach for remote booting generally pertains to having a device that is capable of remote booting (a network device typically) and having the expansion ROM boot proxy code physically present in the device that is connected physically/directly connected to that host. In particular, these devices are not shared among multiple host servers. In a normal network booting process, when the processor is powered-on the pre OS/environment such as BIOS, UEFI or OpenBoot starts executing. This environment enumerates all the devices on the system and chooses a device to boot the operating system. This choice can be made by the user or the system can go through a list of devices in sequence to boot the system.

Consider the case when the booting occurs over a network device. When a network device is chosen, the expansion ROM on the device is located and executed. The expansion ROM uses the DHCP protocol to get, amongst other things, IP address, and boot image and boot server. It uses the TFTP protocol to download the boot image from the boot server and boot the operating system.

Generally speaking, in the prior art, a system can boot using a remote boot only under the following two conditions:
1) The system has a device in its device tree that supports remote booting and necessary connectivity to a remote boot server. There are devices that don't support remote booting. And there are SR-IOV/multi-function adapters which do not support remote booting on all its functions (only function 0 is typically supported); and
2) The remote boot code in the device should be compatible with the system architecture/environment.

With PCI express based sharing of IO devices among multiple, connected hosts, these above conditions restrict the remote booting facility/capability of a connected host.

The inventors of the present application have recognized that a PCIe switch may implement a logical device/virtual device functionality to present a synthetic device to a connected host. As an example, FIG. 1 is a block diagram depicting a normal shared I/O architecture having a standard PCIe switch 102 controlled by management host 104 running switch management software. Switch 102 services one or more hosts, shown as connected host 106 and connected host 108 (also referred to as “local hosts”), for example servers, PCs, and other computing devices. Also connected to switch are one or more devices 110-116 that typically provide some type of function or service for the connected hosts. Within switch 102 are virtual devices 118-124. Virtual devices 118 and 120 are connected to connected host 106 and virtual devices 122 and 124 are connected to connected host 108. Some of these virtual devices have data paths to physical devices 110-114. The functionality and roles of virtual devices 118-124 are described in U.S. Pat. No. 8,521,941, entitled “MULTI-ROOT SHARING OF SINGLE-ROOT INPUT/OUTPUT VIRTUALIZATION,” issued on Aug. 27, 2013, which is incorporated by reference for all purposes, where a solution was described that used resource redirection methods when multiple hosts are connected using the non-transparent ports of a PCIe switch that supports shared I/O mechanisms. Referring to FIG. 2, U.S. patent application Ser. No. 13/624,871, “PCIe Express Switch With Logical Device Capability” commonly owned by the assignee of the present invention, further discusses enabling a PCIe switch 202 with logical device 214, which is presented to a connected host 204 as a synthetic device in a PCIe switch 202 having a management host 212 and physical devices 206, 208, and 210. In particular, The synthetic device is implemented by device software in a management system host that controls operations of the switch. The synthetic device is presented to a local host connected to the switch. Write operations by the local host are captured thereby enabling the management system to create a shadow copy of local host component queues. The local host loads a driver for the synthetic device. Writes that occur in the local host are reflected in the management system. Shadow queues are created on the management system that reflects command and response queues in the local host. A DMA engine associated with the local host port is set up to automatically trigger on queues in the local host. The contents of U.S. patent application Ser. No. 13/624,871 are hereby incorporated by reference.

### SUMMARY OF THE INVENTION

In one aspect of the invention, a method provided for remote booting using a synthetic device capability is disclosed. In one embodiment a synthetic expansion ROM capability is provide for remote booting, thus eliminating the requirement of a physical expansion ROM. Additionally, booting of different host architectures may be supported. An exemplary system includes a management CPU and associated memory. The host management software presents a synthetic device to a remote host, where the synthetic device includes at least one extension to support remote booting.

In one embodiment a method of remote booting over PCI Express using a synthetic remote book capability is disclosed. A management host software system intercepts probe requests from a host and provides information required for a remote boot. The management host software system may include expansion ROM information to support different host architectures. A synthetic device booting capability may be shown to a host, including the expansion ROM information. Additional support for DHCP and TFTP protocols may be provided.

### BRIEF DESCRIPTION OF THE DRAWINGS

FIG. 1. is a block diagram depicting a shared IO architecture having a standard PCIe switch controlled by a system management host running switch management software in accordance with the prior art;

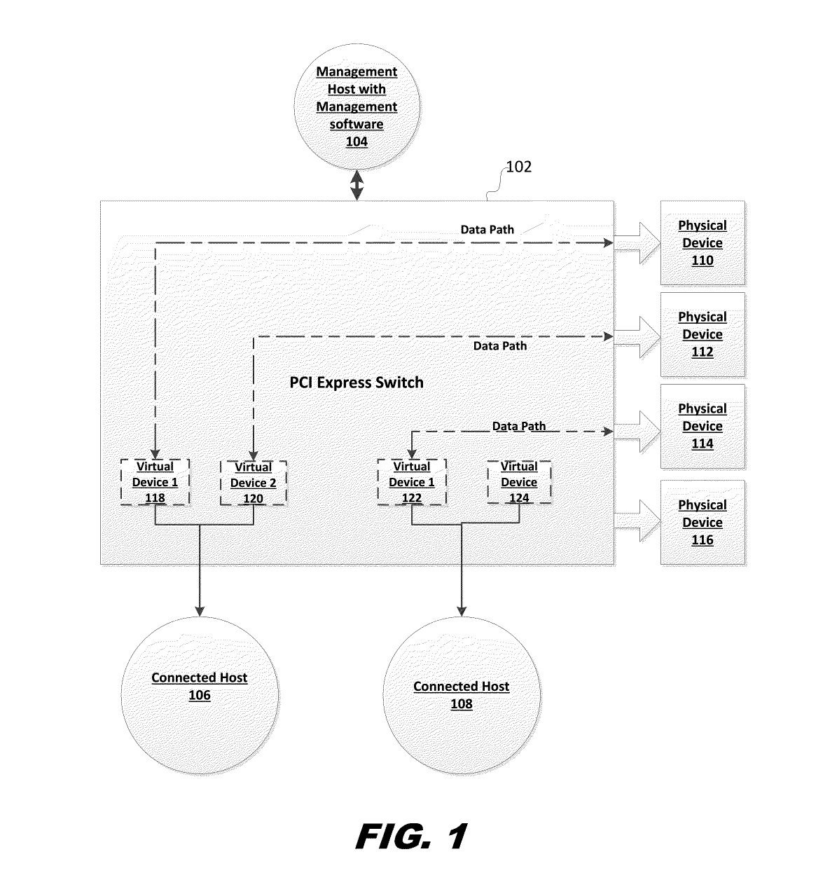

FIG. 2 is a block diagram of shared IO architecture having a synthetic device capability as described in Applicant's commonly owned U.S. patent application Ser. No. 13/624,871;

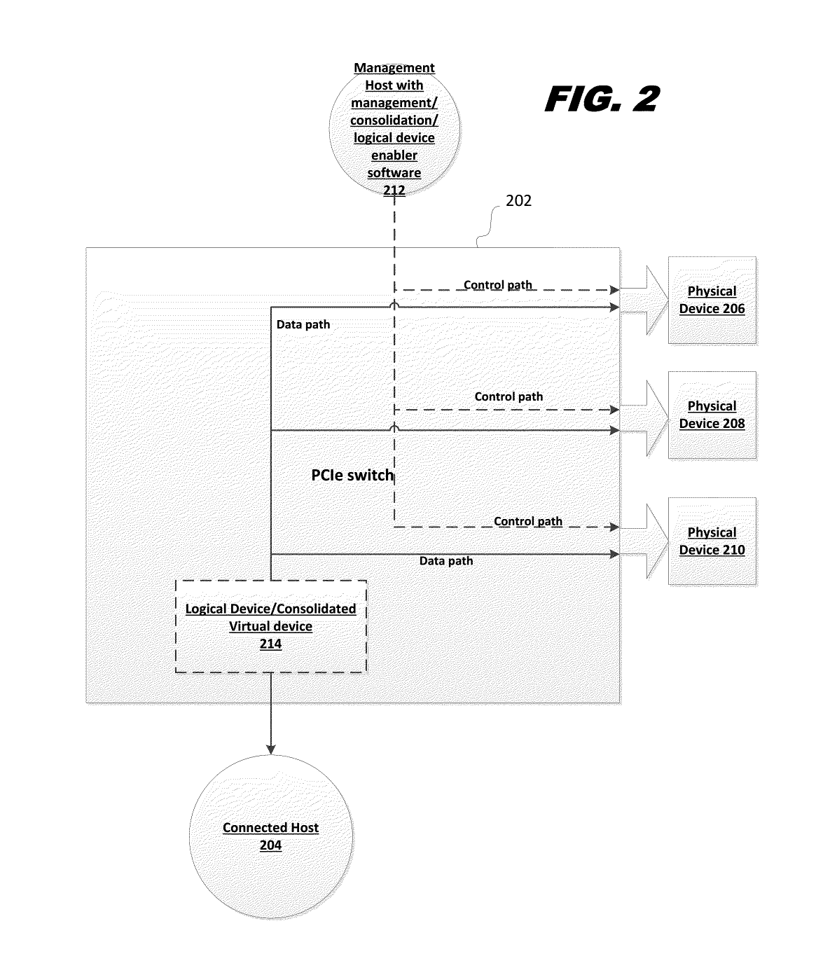

FIG. 3 is a block diagram of a PCIe switch having a synthetic device capability to support remote booting in accordance with an embodiment of the present invention;

FIG. 4 illustrates an exemplary set of management host components/extensions to support remote booting in accordance with an embodiment of the present invention; and

FIG. 5 illustrates an exemplary method of remote booting in accordance with an embodiment of the present invention.

### DETAILED DESCRIPTION OF SPECIFIC EMBODIMENTS

Reference will now be made in detail to specific embodiments of the invention, including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

The present application is generally related to using a synthetic device capability in a PCIe switch to support remote booting. General background on providing a synthetic device capability for other purposes is described in U.S. Pub. No. 2013/00024595, “PCI Express Switch with Logical Device Capability,” which is hereby incorporated by reference for all purposes. U.S. Publ. No. 2013/0024595 describes a capability for enabling operation of a synthetic device in a PCIe switch, including presenting the synthetic device a local host component connected to the switch. Additionally, commonly owned U.S. patent application Ser. No. 14/106,579, “Switch with Synthetic Device Capability,” is also hereby incorporated by reference for background information on providing a synthetic device capability in a PCI Express Switch fabric environment as well as U.S. patent application Ser. No. 13/624,871, “PCIe Express Switch With Logical Device Capability.” The present invention adds new features and capabilities to remote booting on a shared IO PCI express fabric.

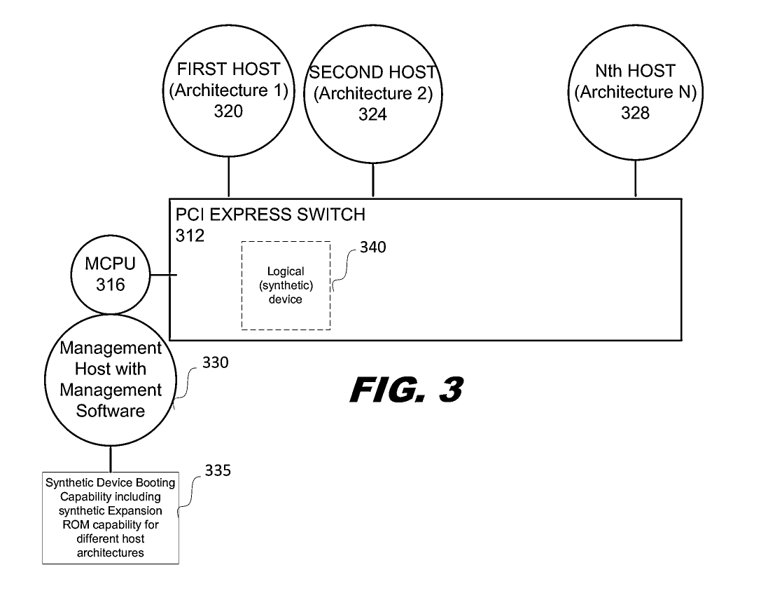

FIG. 3 is a high level block diagram of an embodiment of the present invention, which provides a synthetic device capability to support remote booting. A PCI Express switch 312 may share IO devices (not shown) among one or more connected hosts. A management CPU (MCPU) 316 and associated memory supports a management host and management software 330 for the PCI Express Switch. The management host software 330 of the PCI Express switch supports a synthetic device capability, where a synthetic device is not a physical device. As such, the synthetic device presented to a connected host, such as host 320, host 324, or host 328, does not have a physical expansion ROM. Instead, the expansion ROM capability is provided as a synthetic device extension of the logical (synthetic device) 340. In particular, the management host 330 includes a synthetic device booting capability including a synthetic expansion ROM capability for one or more different host architectures.

The switch 312 thus allows creating and presenting synthetic devices and device extensions that include expansion ROM capabilities. In an embodiment of the present invention, the switch supports a multi-architecture expansion ROM capability in which the expansion ROM information required to boot an arbitrary number of different host architectures (e.g. Host Architectures 1, 2 . . . N) is supported. In embodiments of the present invention the expansion ROM functions may be implemented by the management host 330 as DMA functions (in software) with a Proxy PXE server as part of the management software of ExpressFabric, that connects either to a real PXE server in the network that the ExpressFabric (management software) can connect to or use the local storage to provide boot images.

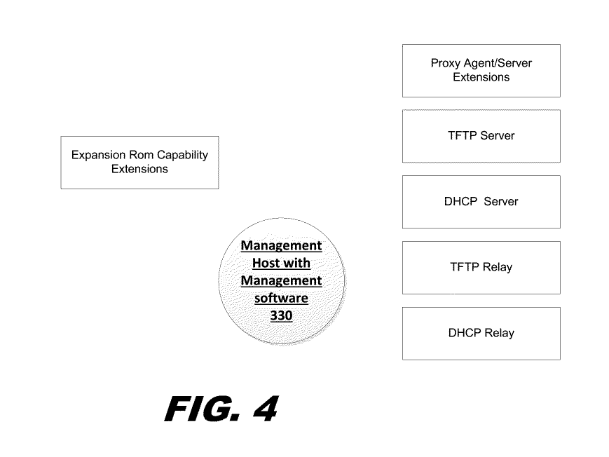

FIG. 4 illustrates an exemplary set of components for the management host in accordance with an implementation. Referring to FIG. 4, management software extensions may include:
1) Expansion ROM (EPROM) capability on DMA functions and handling read/write of that EPROM area; and
2) Providing a proxy agent to each host server as the EROM image that talk to a proxy server component in the management software. A proxy server component in the management software bridges the connected host server to the real PXE server in the Ethernet fabric. As examples, TFTP servers, DHCP servers, TFTP relays, and DHCP relays may be supported.

Additionally, in one embodiment an exemplary set of components further includes:
1) ExpressFabric switches and connected host servers; and
2) An Ethernet fabric that contains a PXE server that hands out boot images.

Note that it is also possible to store pre-made boot images for various hosts in the management software (as a database stored in a flash/storage medium connected to the management agent of the PCI express Fabric), and serve that boot image, instead of going to an outside PXE server. Both the above methods are examples/embodiments for this current invention.

In one embodiment, remote booting is made fully configurable and managed by the management host software (and not by firmware or hardware) from stored memory images. This permits a connected host, such as host 320, 324, or 328, to overcome the limitations of conventional PCI and boot over the network. Some aspects of embodiments of the present invention include:

A physical device need not exist. The Express fabric can provide a synthetic device that is provided by the management software. Some aspects and benefits may include:
1) The host can be of any architecture. The management software then provide the correct Expansion ROM depending on the host architecture;
2) The management software can intercept the network booting process and provide proxy services for network boots; and
3) The management software can intercept the network booting process and provide boot images from the as simple memory images.

One aspect of the remote booting approach is that the synthetic device presentation capabilities of the PCI Express switch also allows showing a synthetic capability of network booting to a connected host. This capability can be shown to exist on either a real or a synthetic device. The connected host (e.g., host 320, 324, or 328) discovers this and uses this capability to boot using this capability. In the prior art, remote booting is typically enabled through the expansion ROM capability of PCI configuration space of devices that support remote booting. System boot code (BIOS), while scanning the devices present at the time of booting, looks at this expansion ROM capability and if configured, executes this memory image. In contrast, in the present invention the expansion ROM capability is provided via a synthetic device capability. The synthetic device capability allows the switch to add the functionality of the expansion ROM to the device even if the real device does not have an expansion ROM. It is also possible to present a device with these capabilities even when the device does not exist.

### EXAMPLE IMPLEMENTATION METHOD

An example of a method of implementing remote booting over a real device with a synthetic capability or a synthetic device over a network is now described. This method is architecture agnostic and can be used for booting processors of different kinds over the same device.

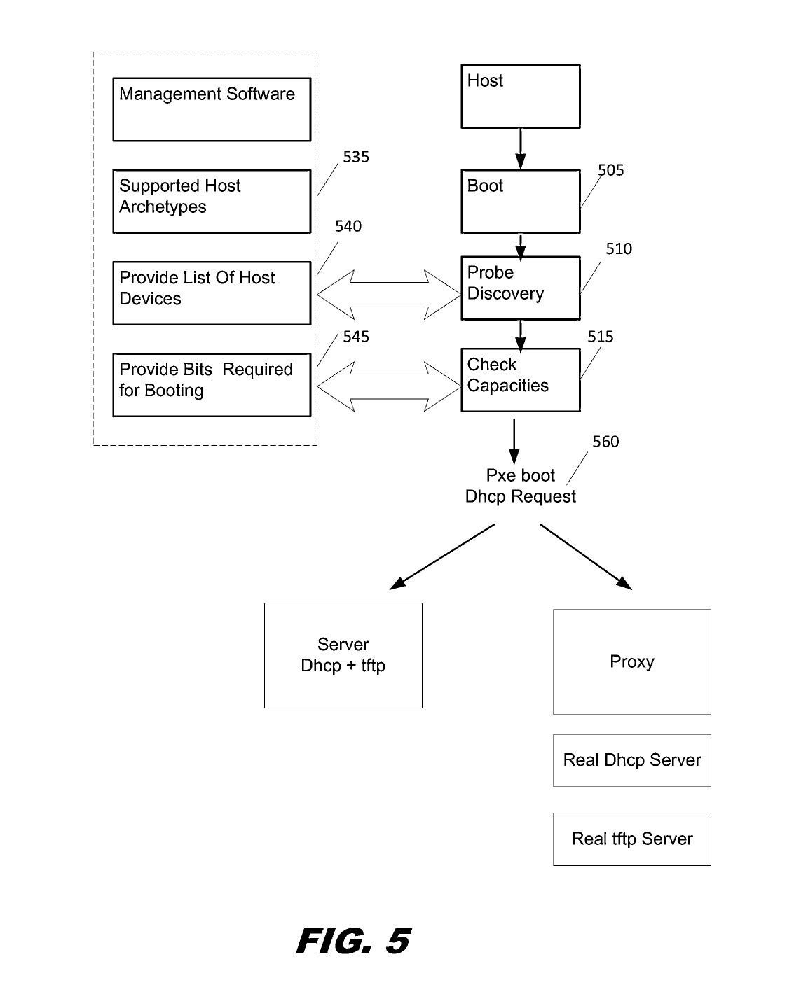

FIG. 5 illustrates interactions between the management software and a host. The management software includes a block 535 to define what host architectures are supported and related support information. A host implements a boot 505, followed by a probe discovery 510 block to probe for devices, and a check capabilities block 515 to check for device capabilities. In this process the management software intercepts the probes from the host. The management software provides the host on the Express Fabric with a list of devices and their capabilities. When a host on the Express Fabric boots, it probes for the list of PCIe devices. The management software intercepts these probes and provides the host with a device tree and when the host probes each device for its capabilities the management software again intercepts these requests and returns the appropriate capabilities. Additionally, the management software provides the bits required for booting. Both the device and the capabilities can be synthetic but for the host they are physically present. Additional processes may be included to handle dhcp requests and TFTP requests such as a PxE boot 560 and DHCP request process, which is described below in more detail.

An example management software configuration will now be described. In this example, the management software acts as a dhcp and TFTP relay i.e. the management software will forward, with appropriate transformations, packets to outside servers to handle the boot request. These packets will include dhcp requests and TFTP requests.

In one embodiment the management software is configured with three things for booting with synthetic network devices:
1. The host port that needs a synthetic device to boot from.
2. The CPU architecture of the host system.
3. The expansion ROM bit stream required by the host to boot. Different CPU architectures require different expansion ROM bit streams.

In one embodiment, when the host boots up, it starts at the PCIe root complex and probes for all devices. These probes are intercepted by the management software that provides the host with a device hierarchy. The hierarchy may be a real hierarchy consisting of real devices or a synthetic hierarchy consisting of a synthetic hierarchy or a combination of real and synthetic devices. Once the host finds a PCIe device, it probes the capabilities of the device. This probe is intercepted by the management software, which returns the capabilities. Once again the management software can return real capabilities (if the device is real), synthetic capabilities (for real or synthetic capabilities) or a combination of real and synthetic capabilities. If a host is configured with a synthetic device for remote booting, a synthetic device is presented in the device hierarchy of the host. When the host probes the capabilities of this synthetic device the management software will return capabilities that indicate the presence of the expansion ROM. When the host tries to read the expansion ROM, it is intercepted by the management software, that returns the correct bit stream depending on the architecture of the host.

Once the host reads the expansion ROM for network boot, it will follow the standard protocols of DHCP and TFTP to start the PXE booting. The management software intercepts the writes to the synthetic device and forwards the protocol data over a connected Ethernet network.

Additional configuration and execution details are now described for an embodiment of the present invention. In one embodiment the management software is configured with the details of which hosts need a synthetic network booting device, host architecture and the expansion ROM needed for that host that is architecture specific. The management software is also configured to know how to handle the expansion ROM requests. For example if the host sends a DHCP request, the management software can be configured to forward it or reply to it. It can also reply or relay other requests such as TFTP requests.

When the host boots, it will probe for PCIe devices. This probe is intercepted by the management software and depending on the configuration it is presented with a synthetic device with expansion ROM capabilities. The Host will read from the capabilities register about expansion ROM capability. This read is again intercepted by the management CPU and depending on the configuration the device can be shown to have expansion ROM capability. The Host will read the expansion ROM. This read is trapped once again by the Management software, and depending on the host architecture, it will return the appropriate expansion ROM.

Network booting of a host involves a PxE boot that starts with a dhcp. The management software can trap the dhcp request and either forward the packet to a existing DHCP server or return a canned DHCP reply to the host. Once the host request receives the DHCP reply that consists of the host's IP address and the TFTP server's name and other system parameters, it will connect to the TFTP server to read the operating system bit stream. The Management software can, once again, forward the connections to an existing TFTP server or return the canned reply from the local resources.

Additional alternate embodiments are contemplated. As previously discussed, the present application is generally related to using a synthetic device capability in a PCIe switch to support remote booting. The potential for the PCIe switch to include shared JO devices and the use of DMA functions was previously discussed. Additional device capabilities were discussed in detail in the patents and patent applications of the assignee that are incorporated by reference. Consequently, it will thus be understood that the synthetic expansion ROM capability may be included in implementations that include a shared JO device or built in DMA functions of ExpressFabric, instead of creating a whole new synthetic device for this purpose.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A method of remote booting of one or more of a plurality of hosts through a PCIe switch, the method comprising:
providing, by management system host software, a synthetic device having a synthetic device extension that includes expansion ROM capabilities; and
utilizing synthetic expansion ROM capabilities of the synthetic device to perform a remote booting of a selected host.

2. The method of claim 1, wherein the expansion ROM capabilities include a multi-architecture expansion ROM capability to support remote booting of a plurality of different host architectures.

3. The method of claim 1, further comprising storing pre-made boot images for various hosts in the management host software.

4. The method of claim 1, further comprising providing a proxy agent for each host server.

5. The method of claim 1, further comprising performing a remote booting of a host connected to the PCIe switch and showing in the synthetic device capability of network booting to the connected host.

6. The method of claim 5, wherein the expansion ROM capability is provided via the synthetic device extension.

7. The method of claim 1, wherein the management system host software provides proxy services for network boots.

8. A PCIe switch, comprising:
a management CPU and associated memory; and
a management host with management software providing a synthetic device having a synthetic expansion ROM capability to perform remote booting of a connected host.

9. The switch of claim 8, wherein the synthetic expansion ROM capabilities include a multi-architecture expansion ROM capability to support remote booting of a plurality of different host architectures.

10. The switch of claim 8, further comprising storing pre-made boot images for various hosts in the management host software.

11. The switch of claim 8, further comprising providing a proxy agent for each host server.

12. A method of remote booting through a PCIe switch using a synthetic device, comprising:
intercepting, by management software of a management host, probes by a remote host for a list of PCIe devices and corresponding device capabilities; and
providing to the remote host, by the management software, a device tree and with a list of devices and their capabilities to the host, including bits required for booting;
wherein a synthetic expansion ROM capability is provided by the management software to the remote host to support remote booting without requiring a physical expansion ROM device.

13. The method of claim 12, wherein remote booting is supported for a plurality of different host architectures.

14. The method of claim 12, further comprising storing pre-made boot images for various hosts in the management host software.

15. The method of claim 12, further comprising providing a proxy agent for each host server.

16. A system comprising a PCI express switch in combination with a management system having a synthetic expansion ROM capability supporting remote booting with a plurality of hosts.

17. The system of claim 16, wherein the management software intercepts probes by a host and provides a device tree with a list of device and capabilities to the host, including bits required for booting.

18. A method of booting with synthetic network device, comprising:
configuring a management system host software of a PCIe Express fabric switch with booting information including the host port that needs a synthetic device to boot from, the CPU architecture of the host system, and the expansion ROM bit stream required by the host to boot; and
utilizing the management system host software to intercept probe requests from a host boot process and providing a compatible synthetic expansion ROM capability to boot the host.
